(19) United States
(12) Patent Application Publication
(10) Pub. No.: US 2012/0054524 A1
(43) Pub. Date: Mar. 1, 2012

(54) METHOD AND SYSTEM FOR REDUCING POWER CONSUMPTION OF PERIPHERALS IN AN EMERGENCY SHUT-DOWN

(75) Inventor: Ido BEN-TSION, Ramat Gan (IL)

(73) Assignee: INFINIDAT LTD., Herzliya (IL)

(21) Appl. No.: 12/872,303

(22) Filed: Aug. 31, 2010

(51) Int. Cl. G06F 1/32

(52) U.S. Cl. 713/324

(57) ABSTRACT

In order to avoid loss of data, computer systems are often connected to a UPS which provide power backup in case of an emergency shutdown resulting from a power failure. However, as UPS devices are costly, they take up a lot of physical space, and can provide power for a limited period of time, it would be advantageous to improve the efficiency of UPS devices and enable to utilize as much as possible of the UPS power in order to save data to a permanent storage before shutdown. There is provided a method and system for controlling the operation of one or more fans in computer systems, in response to an indication of a power failure, and thereby reduce their power consumption, so as to provide more power for writing write-pending data to non-volatile data storage.

### FIELD OF THE INVENTION

This invention relates to protection against loss of data stored on a computer system during an emergency shutdown situation.

### BACKGROUND OF THE INVENTION

In many modern computer applications, the integrity of data is of great importance and cannot be compromised even in case of an emergency shutdown or other failure within the computer system.

For example, often in a computer system, host processors are operatively coupled to one or more permanent storage subsystems via a storage protocol. A host processor may process a transaction by reading relevant data, performing calculations thereon, and writing the results back. The data may be stored at the permanent storage subsystem(s), wherein the process of transferring data to and from the permanent storage subsystem(s) typically includes temporarily storing data and/or metadata in a volatile cache memory (data and/or metadata stored in a cache memory are referred to hereinafter as “data”).

Caching is employed by many computer systems for improving input/output (I/O) performance between the storage subsystem(s) and the host(s). In addition, the cache memory may be used to improve internal storage system operations such as error logging, recovery, reconstruction, etc. However, at the time of a power failure, any transactions in progress and respective data temporarily stored in the volatile cache may be lost, and the integrity of data may be compromised.

In order to avoid loss of data, such computer systems typically comprise one or more uninterruptible power supply (UPS) units that allow continued activity in the system, even in the face of a sudden power shortage.

The UPS should allow the computer system to remain operating for a period of time long enough for performing tasks that would prevent loss of user data as well as of internal information or metadata. Typically, this means that data that is currently in memory but has not yet been permanently stored in non-volatile media, has to be taken care of during the time allowed by the UPS.

However, UPS devices have several disadvantages. They are costly, they take up a lot of physical space, and can provide power for a limited period of time. Furthermore, even though computer systems are often programmed to complete all crucial tasks, such as saving data to non-volatile storage, within the time provided by the UPS, it may often be the case that a UPS fails to fully charge, and therefore cannot provide the required power for enabling the completion of all pending tasks before it is shut down.

Thus, it would be advantageous to improve the efficiency of UPS devices and enable to utilize as much as possible of the UPS power, even in the case of incomplete charge, in order to save data to the permanent storage before shutdown.

Prior art references considered to be relevant as background to the invention are listed below. Acknowledgement of the references herein is not to be inferred as meaning that these are in any way relevant to the patentability of the invention disclosed herein.

US Patent Application 2006/212644 entitled “Non-volatile backup for data cache” discloses a non-volatile data cache having a cache memory coupled to an external power source and operable to cache data of an external data device such that access requests for the data can be serviced by the cache rather than the external device. A non-volatile data storage device is coupled to the cache memory. An uninterruptible power supply (UPS) is coupled to the cache memory and the non-volatile data storage device so as to maintain the cache memory and the non-volatile storage device in an operational state for a period of time in the event of an interruption in the external power source.

U.S. Pat. No. 7,484,109 discloses a system for placing and maintaining a computer in a standby mode during power failure, the system comprising a mains power failure sensor, a source of standby power, the source of standby power being less than the power available for full operation, a volatile memory arranged to be powered from the source of standby power in the event of a failure of mains power, and a processor operative responsive to the mains power failure sensor to store status information on the volatile memory and reduce power demand of the processor and associated devices to no more than that available from the source of standby power. In an exemplary embodiment, the source of standby power is one of a battery, a capacitor, a flywheel energy storage system and a power over Ethernet connection.

### SUMMARY OF THE INVENTION

According to one aspect of the invention there is provided a computer system comprising: a storage control module operatively coupled to a volatile cache memory and to a non-volatile data storage and being operable to control writing of write-pending data from the volatile cache memory to the non-volatile data storage; a UPS operatively coupled to at least the storage control module, the volatile cache memory and the non-volatile data storage; a power control unit operatively coupled to one or more fans configured for cooling one or more components within the computer system and, responsive to an indication of a power failure, operable to disable at least one of the one or more fans so as to reduce its power consumption and provide extended time for writing the write-pending data to the non-volatile data storage.

According to another aspect of the invention there is provided a method for operating a computer system comprising a storage control module operatively coupled to a volatile cache memory and to a non-volatile data storage, being operable to control writing of write-pending data from the volatile cache memory to the non-volatile data storage, the method comprising: in response to an indication of a power failure, operating a UPS operatively coupled to at least the storage control module, the volatile cache memory and the non-volatile data storage; and, disabling at least one of one or more fans operatively coupled to the computer system, so as to reduce its power consumption rate and provide extended time for writing the write-pending data to the non-volatile data storage.

According to a further aspect of the invention there is provided a power control unit configured to be operatively coupled to a computer system, the computer system comprising at least a storage control module operatively coupled to at least a volatile cache memory and to a non-volatile data storage and being operable to control writing of write-pending data from the volatile cache memory to the non-volatile data storage; and a UPS operatively coupled to at least the storage control module, the volatile cache memory and the non-volatile data storage; the power control unit is configured to be coupled to one or more fans configured for cooling one or more components within the computer system and, responsive to an indication of a power failure, to be operable to disable at least one of the one or more fans so as to reduce its power consumption rate and provide extended time for writing the write-pending data to the non-volatile data storage.

According to yet another aspect of the invention there is provided a program storage device readable by machine, tangibly embodying a program of instructions executable by the machine to perform a method step for operating a computer system comprising a storage control module operatively coupled to a volatile cache memory and to a non-volatile data storage, being operable to control writing of write-pending data from the volatile cache memory to the non-volatile data storage, the method comprising: in response to an indication of a power failure, operating a UPS operatively coupled to at least the storage control module, the volatile cache memory and the non-volatile data storage; and disabling at least one of one or more fans operatively coupled to the computer system, so as to reduce its power consumption rate and provide extended time for writing the write-pending data to the non-volatile data storage.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 illustrates a first generalized functional block diagram of a storage system in accordance with certain embodiments of the present invention;

FIG. 2 illustrates a second generalized functional block diagram of a storage system in accordance with certain embodiments of the present invention;

FIG. 3 illustrates a first generalized flow-chart of operations carried out in accordance with certain embodiments of the present invention; and

FIG. 4 illustrates a second generalized flow-chart of operations carried out in accordance with certain embodiments of the present invention.

### DETAILED DESCRIPTION

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “processing”, “controlling”, “configuring”, “obtaining”, “receiving”, “enabling”, “disabling”, “performing”, or the like, include action and/or processes of a computer that manipulate and/or transform data into other data, said data represented as physical quantities, e.g. such as electronic quantities, and/or said data representing the physical objects. The term “computer” should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof.

The operations in accordance with the teachings herein may be performed by a computer specially constructed for the desired purposes or by a general purpose computer specially configured for the desired purpose by a computer program stored in a computer readable storage medium.

As used herein, the phrase “for example,” “such as”, “for instance” and variants thereof describe non-limiting embodiments of the present invention. Reference in the specification to “one embodiment”, “an embodiment”, “some embodiments”, “another embodiment”, “other embodiments”, “certain embodiments”, “one instance”, “some instances”, “one case”, “some cases”, “other cases” or variants thereof means that a particular feature, structure or characteristic described in connection with the embodiment(s) is included in at least one embodiment of the invention. Thus the appearance of the phrase “one embodiment”, “an embodiment”, “some embodiments”, “another embodiment”, “certain embodiments”, “other embodiments”, “one instance”, “some instances”, “one case”, “some cases”, “other cases” or variants thereof does not necessarily refer to the same embodiment(s).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

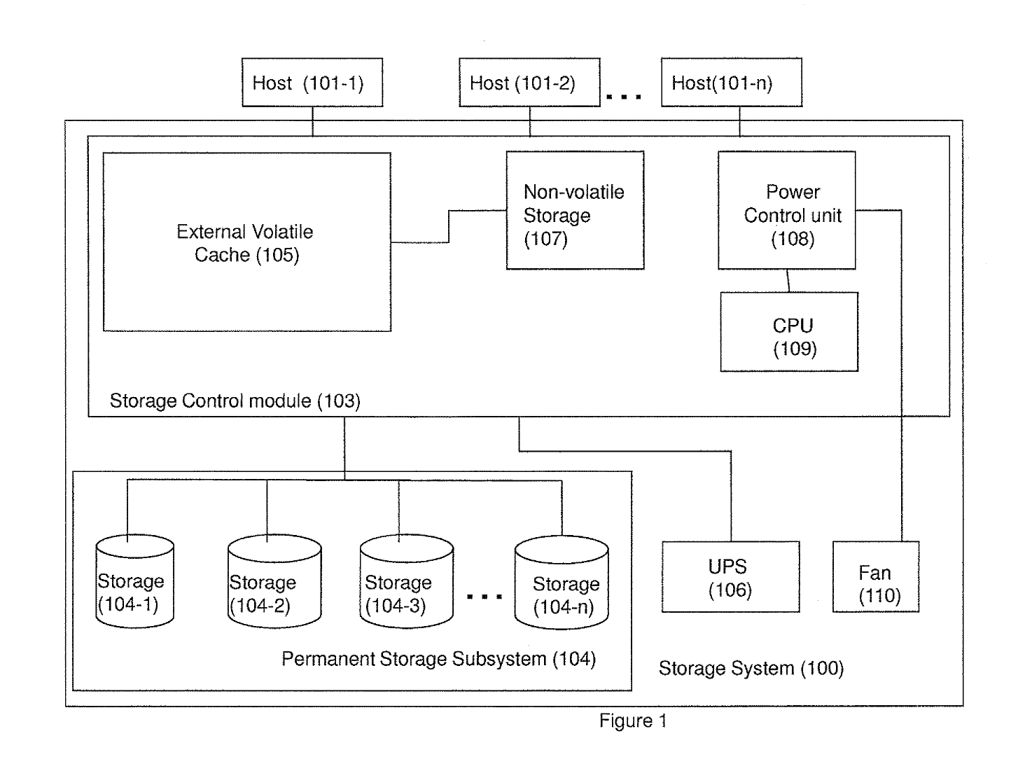

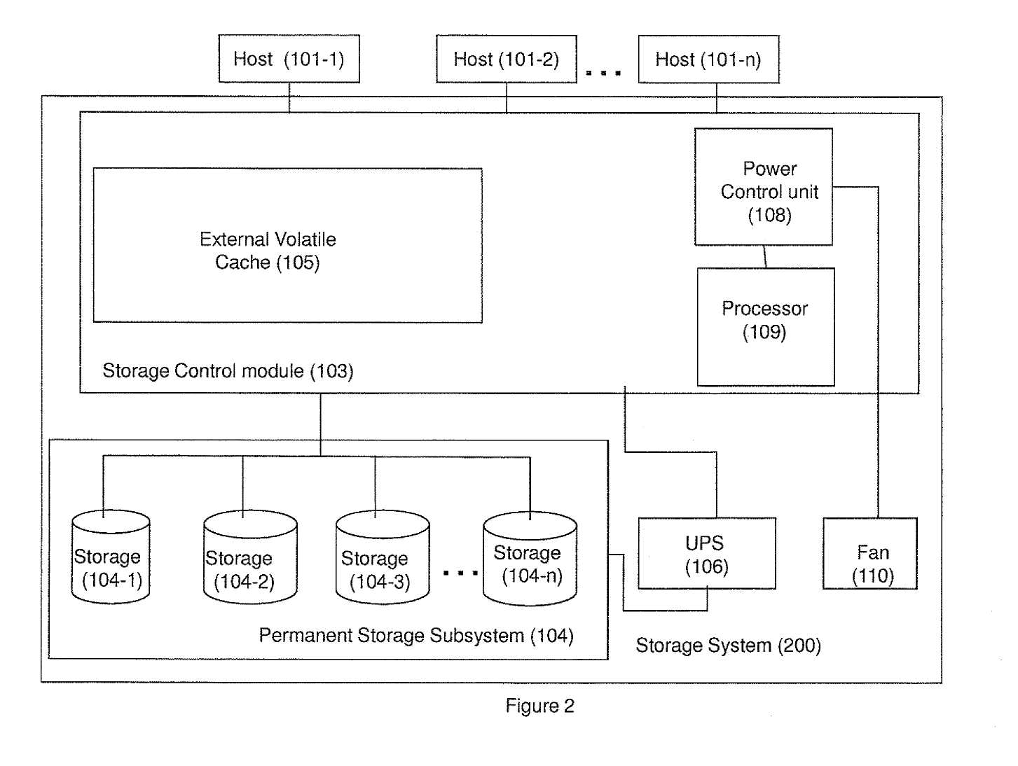

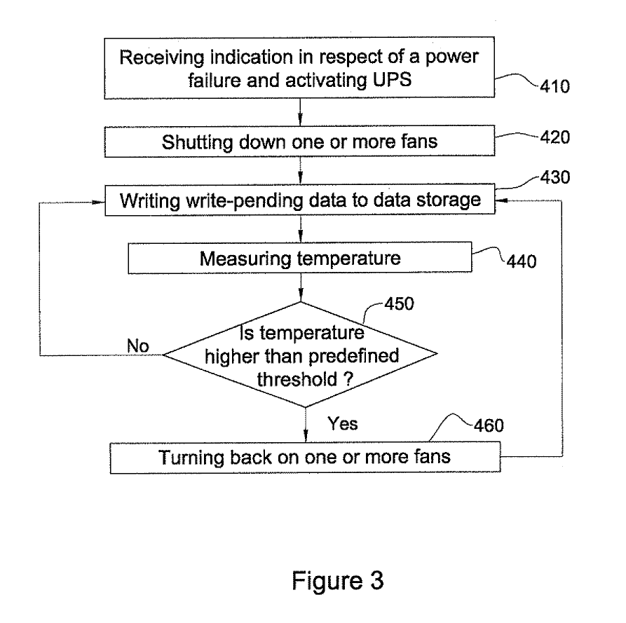

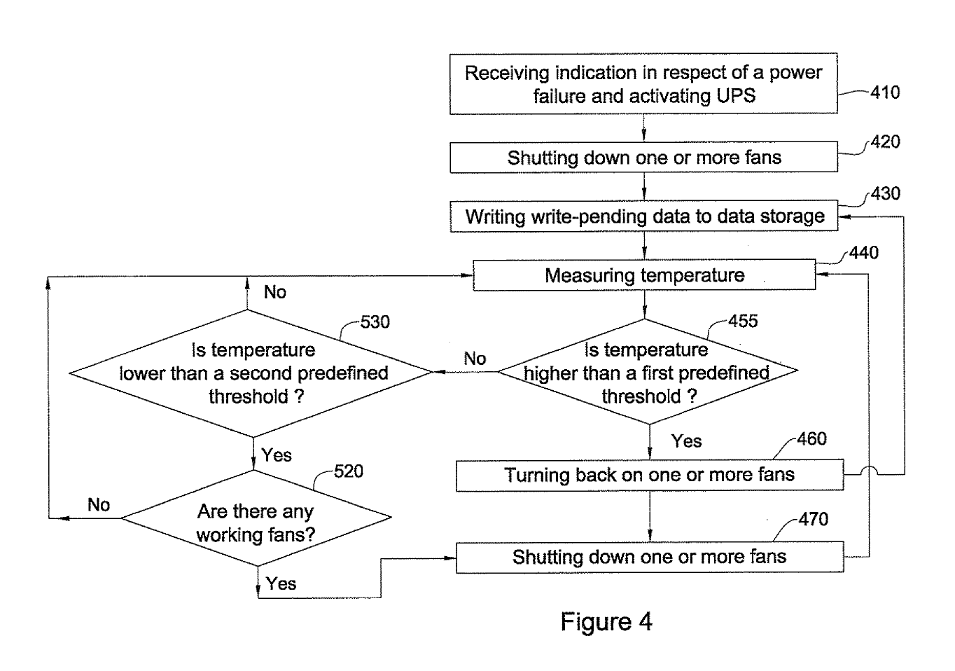

In embodiments of the invention, fewer, more and/or different stages than those shown in FIGS. 3 and 4 may be executed. In embodiments of the invention one or more stages illustrated in FIGS. 3 and 4 may be executed in a different order and/or one or more groups of stages may be executed simultaneously. FIGS. 1 and 2 illustrate a general schematic of the system architecture in accordance with an embodiment of the invention. Each module in FIGS. 1 and 2 can be made up of any combination of software, hardware and/or firmware that performs the functions as defined and explained herein. The modules in FIGS. 1 and 2 may be centralized in one location or dispersed over more than one location. In other embodiments of the invention, the system may comprise fewer, more, and/or different modules than those shown in FIGS. 1 and 2.

Bearing this in mind, attention is drawn to FIG. 1 illustrating a schematic functional diagram of a computer storage system 100 in accordance with certain embodiments of the present invention. The computer system comprises one or more host computers (illustrated as 101-1 to 101-n) sharing common storage means provided by a storage system 100. The storage system comprises a storage control module 103 operatively coupled to one or more host computers (101-1 to 101-n) and to a permanent storage subsystem 104 comprising one or more storage devices (e.g. specialized NAS file servers, general purpose file servers, SAN storage, stream storage device, etc.) illustrated as 104-1, to 104-n. The storage devices may comprise any permanent storage medium, including, by way of non-limiting example, one or more disk drives and/or one or more arrays of disk drives, and may communicate with the host computers and within the storage system in accordance with any appropriate storage protocol. The storage control module 103 is configured to control I/O operations between the host computers and the permanent storage subsystem 104. Upon receiving a write command from a host computer, storage control module 103 enables writing data to at least one storage device of the plurality of storage devices (104-1 to 104-n), and, on receiving a read command from the host computer, enables reading data from at least one storage device of the plurality of storage devices and transmitting this data to the host computer.

The one or more computers (101-1 to 101-n) may be, but are not limited to, a personal or portable computer, a server computer, a PDA, cellular phone or any other apparatus having the appropriate processing infrastructure (software and hardware) for running an appropriate process (e.g. client process) and communicating over a communication network with storage system 100. Server 110 may be, but is not limited to, personal or portable computers. Storage system 100, can be implemented for example, as dedicated server-computer characterized by one or more of the following features: faster CPU, high performance RAM, multiple hard drives and a large storage space.

The storage control module 103 comprises an external volatile cache memory 105 for temporarily storing the data to be written to the storage devices in response to a write command and/or for temporarily storing the data to be read from the storage devices in response to a read command. Volatile cache memory is external in respect of permanent storage subsystem 104. During a write operation the data is temporarily retained in volatile cache memory 105 until subsequently written to one or more data storage devices. Such temporarily retained data is referred to hereinafter as “write-pending” data (also known as “dirty data”). Write pending data in the volatile cache memory 105 may be lost when power supply to the cache memory is interrupted.

The control unit (of storage control module 103) notifies the host computer of the completion of the write operation when the respective data has been written to the cache memory. Accordingly, the write request is acknowledged prior to the write-pending data being stored in the permanent storage subsystem. Once the write-pending data is sent to the respective permanent storage medium, its status is changed from “write-pending” to “non-write-pending”, (also known as “clean data”) and the storage system relates to this data as stored at the permanent storage medium and allowed to be erased from the cache memory.

However, in addition to the volatile cache memory 105, a typical permanent storage subsystem (104) has its internal cache memory (not illustrated in FIG. 1), e.g. each disk drive may have its own internal caching mechanism, or several disk drives may have a shared cache, etc. The internal cache memory enables optimizing the writing process in the permanent storage subsystem. Consequently, for a certain period of time (up to several seconds), data which is identified as “non-write-pending” data is not really stored in a non-volatile storage medium. If a power failure takes place (e.g. a sudden loss of power from the main power sources) precisely at that time, then the data would be lost. Moreover, since the storage system in general has no control or even knowledge of the internal caching system of the permanent storage subsystem, the data is not only lost, but its status is considered by the system as safely stored data. This may create a dangerous situation of false or inconsistent data retrieval after recovery from the power failure. As known in the art, the danger of false or inconsistent data retrieval may be avoided by working in a “write through” mode, i.e., without implementing internal caching in the permanent storage subsystem. However, the “write through” mode may seriously affect the performance of the disk drives and hence is less applicable for mass storage systems and, especially, for enterprise storage systems.

Accordingly, in order to avoid loss of data, storage control module 103 can further comprise (or be associated with) a non-volatile data storage unit 107 which enables to safely store write-pending data in the event of a power failure. Description in respect of non-volatile storage unit 107 is found in PCT application PCT/IL 2009/000818, which is incorporated herein by reference in its entirety. Non-volatile data storage unit 107 is operatively coupled to the volatile cache memory 105. The non-volatile data storage unit 107 may be implemented, by way of non-limiting example, as a non-volatile cache memory, flash memory, disk drive(s), etc., located within storage control module 103 or connected to storage control module 103 as an external unit.

In addition, storage control module 103 is connected to one or more uninterruptible power supply (UPS) units 106 configured to provide power to storage control module 103 in case of power failure. In case non-volatile storage unit 107 and/or the operational cache memory 103 are located externally to storage control module 103, they shall be also directly connected and powered by a UPS 106.

In response to an indication of a power failure, UPS 106 becomes operative to provide power to storage control module 103. In order to avoid any loss of data the UPS 106 provides power at least for the period of time required for writing pending-data to non-volatile storage unit 107. As mentioned above, UPS 106 units are costly, they take up a lot of physical space, and can provide power for a limited period of time. In addition, as further mentioned above, it may happen that a UPS is not fully charged at the time of power failure, (e.g. as a result of a malfunction) and therefore fails to provide the expected power, which is required for completing all crucial tasks before its complete shutdown. Thus it would be advantageous to minimize the number of UPS units which are used while efficiently exploiting the power which is provided by each UPS unit.

To this end, storage control module 103 can further comprise (or be associated with) a power control unit 108 configured to control the operation of peripheral devices. For example, power control unit 108 can be configured to shut down one or more fans responsive to an indication of a power failure.

Typically one or more fans are used for cooling different components of a computer system in order to avoid any damage to these components as a result of overheating. Components which produce heat and are susceptible to performance loss and damage include for example, processing units (e.g. CPU 109) and storage units (e.g. Non-volatile data storage 107, and volatile cache 105). However, since the power supplied by UPS enables to operate storage control module 103 and its associated components only for a limited period of time, the risk of overheating is reduced. Therefore, it is possible to shut down part or all of the fans so as to reduce its power consumption rate and thereby provide extended time for writing the write-pending data to the non-volatile data storage 107.

Power control unit 108 can be further configured to monitor the temperature of storage control module 103 and possibly also the temperature of all or part of its associated components, and control the operation of one or more fans according to the measured temperature. For example, in case the power control unit 108 determines that the temperature exceeds a predefined threshold, it may turn back on one or more fans. To this end power control unit 108 can be associated with one or more thermometers (not shown) for measuring the temperature.

Controlling the operation of the fans is particularly efficient when implemented in combination with a storage system having a non-volatile storage unit which is external to permanent storage subsystem 104, such as non-volatile storage unit 107 illustrated in FIG. 1. In such storage systems, during power failure the write-pending data is written to non-volatile storage unit 107 and not to permanent storage subsystem 104. As non-volatile storage unit 107 is considerably smaller than permanent storage subsystem 104 the writing process generates considerably less heat and therefore it can withstand a longer period of time with less or no operating fans.

FIG. 2 illustrates a second generalized functional block diagram of a storage system in accordance with certain embodiments of the present invention. Contrary to storage system depicted in FIG. 1, the storage system shown in FIG. 2 does not include non-volatile storage which is external to permanent storage subsystem 104. Accordingly, in an emergency power failure scenario, data is transferred from external volatile cache 105 and written to permanent subsystem 104 to avoid loss thereof. To this end UPS 106 provides power to both storage control module 103 and permanent storage subsystem 104. Since permanent storage subsystem 104 is generally larger than non-volatile storage 107 more power is required in order to maintain such a system active during a power failure and more heat is generated by such a system in comparison to the system described above with reference to FIG. 1. However, the same principles which were described above in respect of shutting down one or more fans for the purpose of reducing power consumption by the fans can also be implemented in the storage system illustrated in FIG. 2.

It should be noted that although principles of the invention are described herein with reference to the storage systems shown in FIG. 1 and FIG. 2, it should not be construed as limiting and the same principles can be implemented in any computer system which is supported by a UPS, such as for example a PC.

FIG. 3 illustrates a first generalized flow-chart of operations carried out in accordance with certain embodiments of the present invention. Initially an indication of a power failure is received (Block 410). In response to the indication of a power failure a UPS becomes operable to supply power for a limited period of time, instead of the failing power source. During this time, write-pending data which is stored at external volatile cache 105 is written to permanent data storage in order to avoid any loss of data. Permanent data storage can be for example non-volatile storage 107 or permanent Storage Subsystem 104.

In response to this indication, and in order to reduce energy consumption, one or more fans are turned off (Block 420) and write-pending data is written to the non-volatile storage (Block 430). The operation of fan shutdown can be performed for example by power control unit 108. During the writing process, the temperature of data storage module 103 and possibly some or all of its associated components, is monitored (Block 440) and in case in case it exceeds a predefined threshold, one or more of the fans which were previously turned off, are turned back on (Block 460).

FIG. 4 illustrates a second flow-chart of operations carried out in accordance with certain embodiments of the present invention. The operations described with reference to Block 410-440 are similar to those described above with reference to FIG. 3. In case it is determined that the temperature does not exceed a predefined threshold (Block 455) it is next determined whether the temperature is lower than a second predetermined threshold (Block 530). An affirmative answer indicates that the current temperature allows more fans to be turned off. Accordingly, it is determined whether there are any working fans (Block 520), and if there are, one or more of these fans are turned off (Block 470). These operations enable to continuously update the number of operating fans according to the measured temperature and thereby save power while avoiding damaging the system components (e.g. data storage and CPU) due to increased temperature.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present invention.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1. A computer system comprising:
a storage control module operatively coupled to a volatile cache memory and to a non-volatile data storage and being operable to control writing of write-pending data from the volatile cache memory to the non-volatile data storage;
a UPS operatively coupled to at least the storage control module, the volatile cache memory and the non-volatile data storage;
a power control unit operatively coupled to one or more fans configured for cooling one or more components within said computer system and, responsive to an indication of a power failure, operable to disable at least one of said one or more fans so as to reduce its power consumption and provide extended time for writing said write-pending data to the non-volatile data storage.

2. The system of claim 1 wherein said non-volatile data storage is part of a permanent storage subsystem operatively coupled to said storage control module.

3. The system of claim 1 wherein said non-volatile data storage is a storage which is external to a permanent storage subsystem, operatively coupled to said storage control module.

4. The system of claim 1 wherein said power control unit is further operable to monitor the temperature of at least one component of said one or more components, and to re-activate at least one said disabled fan, in case said temperature exceeds a predefined threshold.

5. The system of claim 1 wherein said non-volatile storage can be a flash memory or one or more disk drives.

6. A method for operating a computer system comprising a storage control module operatively coupled to a volatile cache memory and to a non-volatile data storage, being operable to control writing of write-pending data from the volatile cache memory to the non-volatile data storage, the method comprising:
in response to an indication of a power failure, operating a UPS operatively coupled to at least the storage control module, the volatile cache memory and the non-volatile data storage; and,
disabling at least one of one or more fans operatively coupled to said computer system, so as to reduce its power consumption rate and provide extended time for writing said write-pending data to the non-volatile data storage.

7. The method of claim 6 wherein said non-volatile data storage is part of a permanent storage subsystem operatively coupled to said storage control module.

8. The method of claim 6 wherein said non-volatile data storage is storage which is external to a permanent storage subsystem operatively coupled to said storage control module.

9. The method of claim 6 further comprising: monitoring the temperature of at least one component within said computer system and in case said temperature exceeds a predefined threshold, re-activating at least one fan.

10. The method of claim 6 further comprising:
monitoring the temperature of at least one component within said computer system; and
in case said temperature exceeds a predefined threshold re-activating at least one fan;
in case said temperature is lower than a predefined threshold, de-activating one or more operating fans; thereby reducing the power consumption by said one or more fans, while avoiding damage which may result from overheating.

11. A power control unit configured to be operatively coupled to a computer system, the computer system comprising at least a storage control module operatively coupled to at least a volatile cache memory and to a non-volatile data storage and being operable to control writing of write-pending data from the volatile cache memory to the non-volatile data storage; and,
a UPS operatively coupled to at least the storage control module, the volatile cache memory and the non-volatile data storage;
said power control unit is configured to be coupled to one or more fans configured for cooling one or more components within said computer system and, responsive to an indication of a power failure, to be operable to disable at least one of said one or more fans so as to reduce its power consumption rate and provide extended time for writing said write-pending data to the non-volatile data storage.

12. A program storage device readable by machine, tangibly embodying a program of instructions executable by the machine to perform a method step for operating a computer system comprising a storage control module operatively coupled to a volatile cache memory and to a non-volatile data storage, being operable to control writing of write-pending data from the volatile cache memory to the non-volatile data storage, the method comprising:
in response to an indication of a power failure, operating a UPS operatively coupled to at least the storage control module, the volatile cache memory and the non-volatile data storage; and,
disabling at least one of one or more fans operatively coupled to said computer system, so as to reduce its power consumption rate and provide extended time for writing said write-pending data to the non-volatile data storage.
